(19) United States
(12) Patent Application Publication
(10) Pub. No.: US 2011/0116689 A1
(43) Pub. Date: May 19, 2011

(54) System and method for classification of digital images containing human subjects characteristics

(76) Inventors: Jonathan Yen, San Jose, CA (US); William C. Kress, Mission Viejo, CA (US)

(21) Appl. No.: 12/592,110

(22) Filed: Nov. 19, 2009

(51) Int. Cl. G06K 9/00

(52) U.S. Cl. 382/118; 382/165

(57) ABSTRACT

The subject application is directed to a system and method for digital image classification. A first data set that includes a data range that corresponds to a first flesh tone range derived from measured flesh tones of subjects in a first ethnicity class is stored memory. A second data set having a data range that corresponds to a second flesh tone range derived from measured flesh tones of subjects in a second ethnicity unique to the first ethnicity is stored in memory. The data sets being encoded in a three dimensional color space. Image data is then received that includes a human subject. A facial region is isolated and image data in the facial region is compared with each data set via a processor operable with the memory. An image correction signal is generated representing whether the facial region aligns with the first data set or the second data set.

### BACKGROUND OF THE INVENTION

The subject application is directed generally to classification of electronic images. The application is particularly applicable to classification of human subject depicted in electronic images.

Early image capturing systems employed photosensitive chemicals working in conjunction with cameras having shutters and lenses. The initial image capture was completed by positioning a camera lens relative to light and a subject, and exposing photosensitive material to light coming from the subject. A secondary process involved developing the exposed material in one or more chemical bath compositions to fix the captured image. While some limited control of the capture image properties could be accomplished during the developing process, most of the critical control came prior to exposure. Artifacts, such as darkened subjects, would be addressed by positioning the subject in front of the camera, with a light source to the camera's rear. Thus, the subject would be illuminated better relative to the background, giving desired detail to the subjects. However, in certain situations, it is not practicable or desirable to position subjects relative to lighting and a camera, resulting in images where details of the subject are poorly defined.

More recently, images are captured electronically via solid-state devices. Images are captured in a digitally encoded file. Thus, mathematical operators on captured image data can be used to enhance or adjust quality of renderings from digitally captured images.

### SUMMARY OF THE INVENTION

In accordance with one embodiment of the subject application, there is provided a system and method for digital image classification. A first data set encoded in a three dimensional color space is first stored in a memory, with the first data set including a data range that corresponds to a first flesh tone range derived from measured flesh tones of a plurality of subject in a first ethnicity class. A second data set encoded in a three dimensional color space is then stored in memory. The second data set includes a data range that corresponds to a second flesh tone range derived from measured flesh tones of a plurality of subjects in a second ethnicity class unique to the first ethnicity class. Image data, encoded in a multidimensional color space, is then received that includes data corresponding to at least one human subject. At least one facial region is then isolated in the received image data. Image data in the facial region is then compared with the first data set and the second data set via a processor operating in conjunction with the memory. An image correction signal is then generated representing whether the facial region is aligned with the first data set or the second data set in accordance with an output of the comparison.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawings will be provided by the Office upon request and payment of the necessary fee. The subject application is described with reference to certain figures, including:

FIG. 1 is an overall diagram of a digital image classification system according to one embodiment of the subject application;

FIG. 2 is a block diagram illustrating device hardware for use in the digital image classification system according to one embodiment of the subject application;

FIG. 3 is a functional diagram illustrating the device for use in the digital image classification system according to one embodiment of the subject application;

FIG. 4 is a block diagram illustrating controller hardware for use in the digital image classification system according to one embodiment of the subject application;

FIG. 5 is a functional diagram illustrating the controller for use in the digital image classification system according to one embodiment of the subject application;

FIG. 6 is a diagram illustrating a workstation for use in the digital image classification system for according to one embodiment of the subject application;

FIG. 7 is a block diagram illustrating a digital image classification system according to one embodiment of the subject application;

FIG. 8 is a functional diagram illustrating a digital image classification system according to one embodiment of the subject application;

FIG. 9 is a flowchart illustrating a method for digital image classification according to one embodiment of the subject application;

FIG. 10 is a flowchart illustrating a method for digital image classification according to one embodiment of the subject application;

FIG. 11 is a flowchart illustrating a method for digital image enhancement according to one embodiment of the subject application;

FIG. 12 is an example of a backlit scene input image and associated accumulated normalized histogram in accordance with the system for digital image classification according to one embodiment of the subject application;

FIG. 13 depicts example input images of backlit human subject in accordance with the system for digital image classification according to one embodiment of the subject application;

FIG. 14 illustrates an input image of FIG. 12, over-corrected image and adjusted corrected image in accordance with the system for digital image classification according to one embodiment of the subject application;

FIG. 15 is another example input image of a human subject in accordance with the system for digital image classification according to one embodiment of the subject application;

FIG. 16 is an example of a facial input region and facial tone clusters of FIG. 14 in accordance with the system for digital image classification according to one embodiment of the subject application;

FIG. 17 is an example illustrating a further cropping of the input region of FIG. 15 and associated cluster data in accordance with the system for digital image classification according to one embodiment of the subject application;

FIG. 18 is a rounded example the image of FIG. 16 and associated facial tone clusters in accordance with the system for digital image classification according to one embodiment of the subject application;

FIG. 19 an example of a facial tone cluster for a darker skin tone input image in accordance with the system for digital image classification according to one embodiment of the subject application;

FIG. 20 depicts example input images under various lighting conditions in accordance with the system for digital image classification according to one embodiment of the subject application;

FIG. 21 illustrates a base model for lighter facial tones in accordance with the system for digital image classification according to one embodiment of the subject application;

FIG. 22 illustrates a base model for darker facial tones in accordance with the system for digital image classification according to one embodiment of the subject application;

FIG. 23 illustrates a combined lighter and darker facial tone cluster in accordance with the system for digital image classification according to one embodiment of the subject application;

FIG. 24 illustrates a two-dimensional depiction of the facial tone cluster base models in accordance with the system for digital image classification according to one embodiment of the subject application;

FIG. 25 illustrates a final example of the lighter and darker facial tone cluster models in accordance with the system for digital image classification according to one embodiment of the subject application;

FIG. 26 depicts a cross section of a facial tone cluster and corresponding matrix in accordance with the system for digital image classification according to one embodiment of the subject application;

FIG. 27 illustrates a bounding box of the cross section of FIG. 25 in accordance with the system for digital image classification according to one embodiment of the subject application;

FIG. 28 depicts lighter facial tone cluster boundaries in accordance with the system for digital image classification according to one embodiment of the subject application;

FIG. 29 is an example input image and associated cropping in accordance with the system for digital image classification according to one embodiment of the subject application;

FIG. 30 is an example overlap of the image of FIG. 28 in accordance with the system for digital image classification according to one embodiment of the subject application;

FIG. 31 is an example showing the lighter cluster model boundaries and corresponding cross section of the input image in accordance with the system for digital image classification according to one embodiment of the subject application;

FIG. 32 is an example depicting overlap pixels of an input image in accordance with the system for digital image classification according to one embodiment of the subject application;

FIG. 33 is an example input image, cropped image, and overlaps in light and dark tones in accordance with the system for digital image classification according to one embodiment of the subject application;

FIG. 34 is another example input image, cropped image, and overlaps in light and dark tones in accordance with the system for digital image classification according to one embodiment of the subject application; and

FIG. 35 is a further example input image, cropped image, and overlaps in light and dark tones in accordance with the system for digital image classification according to one embodiment of the subject application.

### DETAILED DESCRIPTION OF THE PREFERRED EMBODIMENT

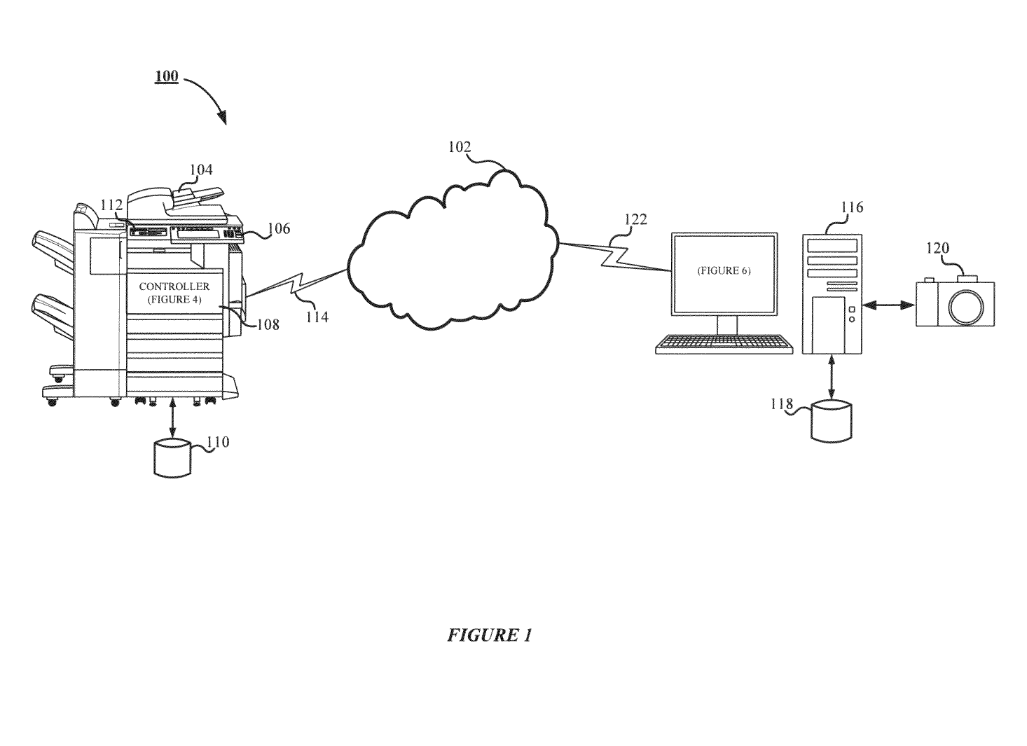

The subject application is directed to a system and method for digital image classification. In particular, the subject application is directed to a system and method for the classification of human subject depicted in electronic images. More particularly, the subject application is directed to a system and method for the detection and classification of the ethnicity of a human subject in a digital image for appropriate enhancement of the human subject in an electronic image. It will become apparent to those skilled in the art that the system and method described herein are suitably adapted to a plurality of varying electronic fields employing data detection and correction, including, for example and without limitation, communications, general computing, data processing, document processing, financial transactions, vending of products or services, or the like. The preferred embodiment, as depicted in FIG. 1, illustrates a document or imaging processing field for example purposes only and is not a limitation of the subject application solely to such a field.

Referring now to FIG. 1, there is shown an overall diagram of a type system 100 for digital image classification in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

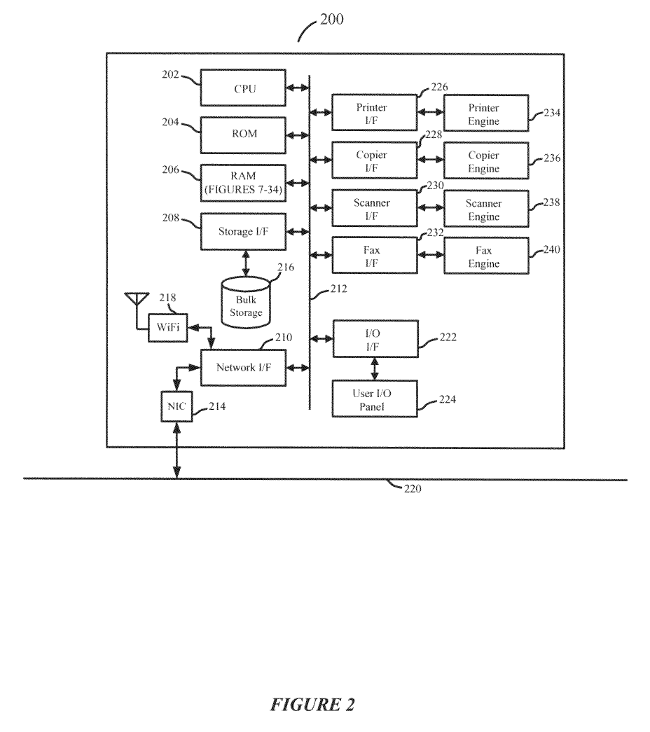

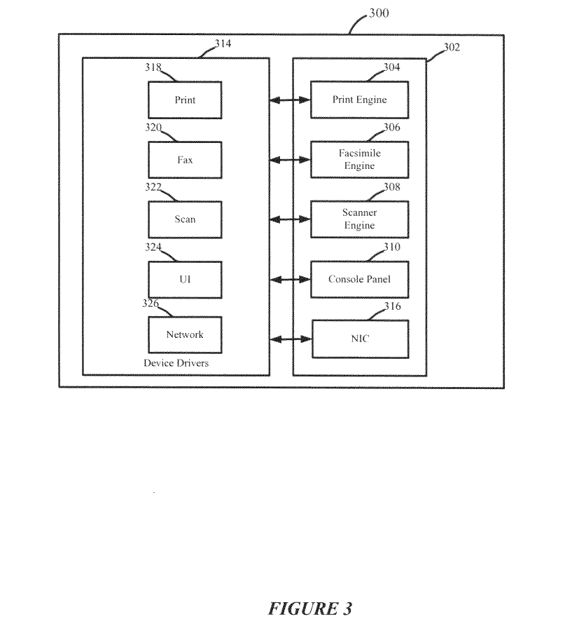

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

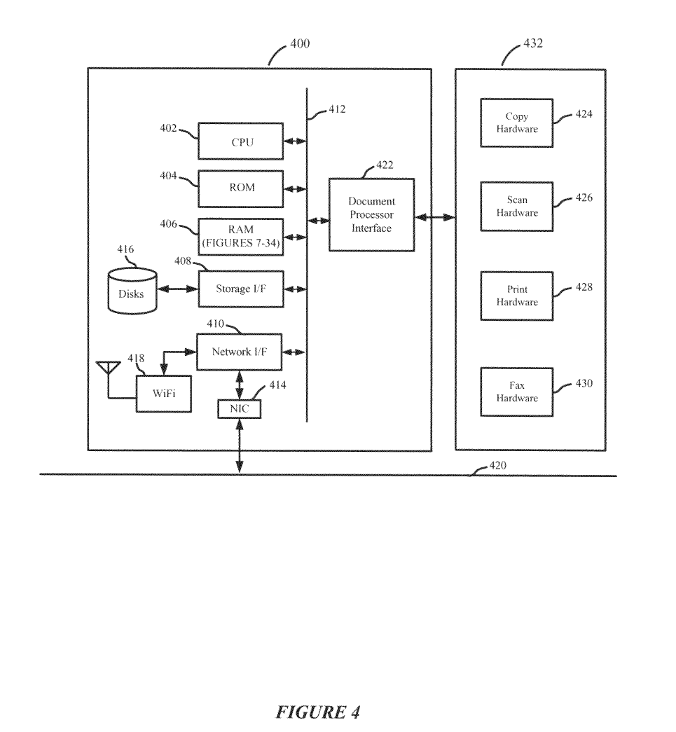

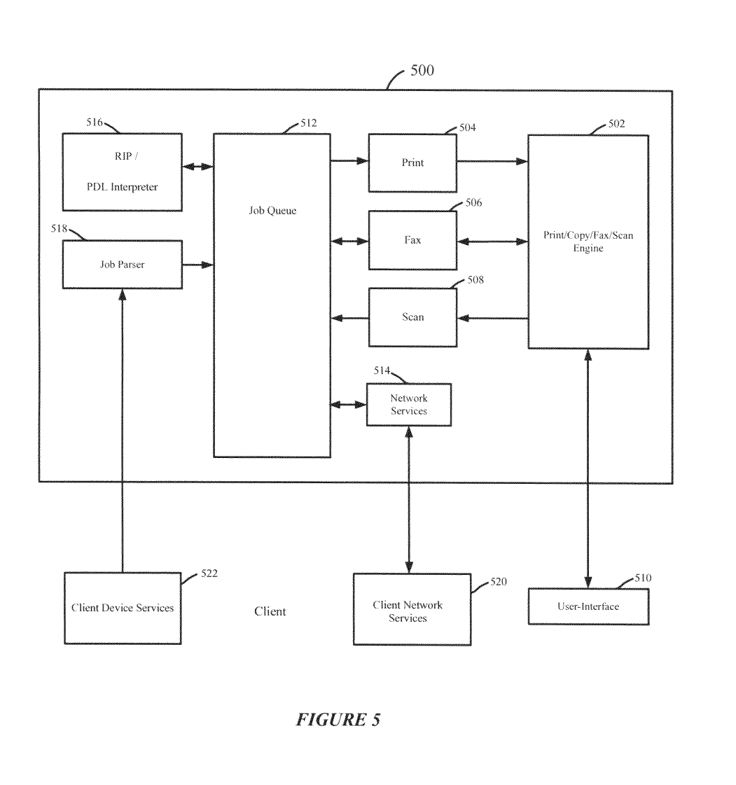

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for digital image enhancement. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like. The document processing device of FIG. 1 also includes a portable storage device reader 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Also depicted in FIG. 1 is a user device, illustrated as a computer workstation 116 in data communication with the computer network 102 via a communications link 122. It will be appreciated by those skilled in the art that the computer workstation 116 is shown in FIG. 1 as a workstation computer for illustration purposes only. As will be understood by those skilled in the art, the computer workstation 116 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the workstation 116 further includes software, hardware, or a suitable combination thereof configured to interact with the document processing device 104, or the like.

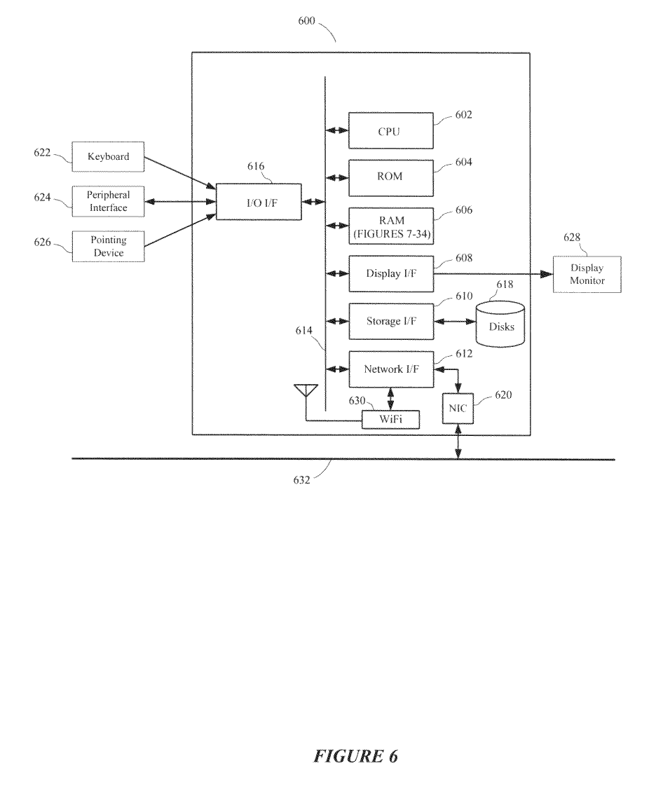

The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the computer workstation 116 is suitably adapted to provide document data, job data, user interface data, image data, monitor document processing jobs, employ thin-client interfaces, generate display data, generate output data, or the like, with respect to the document rendering device 104, or any other similar device coupled to the computer network 102. The functioning of the computer workstation 116 will better be understood in conjunction with the block diagram illustrated in FIG. 6, explained in greater detail below.

Communicatively coupled to the computer workstation 116 is a suitable memory, illustrated in FIG. 1 as the data storage device 118. According to one embodiment of the subject application, the data storage device 118 is any mass storage device known in the art including, for example and without limitation, magnetic storage drives, a hard disk drive, optical storage devices, flash memory devices, or any suitable combination thereof. In accordance with one embodiment of the subject application, the data storage device 118 is suitably adapted to store scanned image data, modified image data, document data, image data, color processing data, or the like. It will be appreciated by those skilled in the art that while illustrated in FIG. 1 as being a separate component of the system 100, the data storage device 118 is capable of being implemented as an internal storage component of the computer workstation 116, such as, for example and without limitation, an internal hard disk drive, or the like

Additionally, the system 100 of FIG. 1 depicts an image capture device, illustrated as a digital camera 120 in data communication with the workstation 116. The skilled artisan will appreciate that the camera 120 is representative of any image capturing device known in the art, and is capable of being in data communication with the document processing device 104, the workstation 116, or the like. In accordance with one embodiment of the subject application, the camera 120 is capable of functioning as a portable storage device via which image data is received by the workstation 116, as will be understood by those skilled in the art.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the computer workstation 116, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi; WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

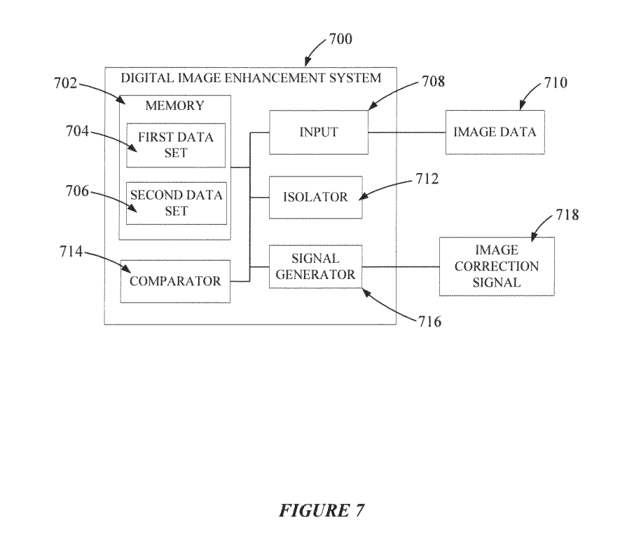

Turning now to FIG. 7, illustrated is a block diagram of a system 700 for digital image classification in accordance with one embodiment of the subject application. The system 700 includes a memory 702 that stores a first data set 704 encoded in a three dimensional color space. According to one embodiment of the subject application, the first data set 704 includes a data range corresponding to a first flesh tone range derived from measured flesh tones of subjects in a first ethnicity class. The memory 702 of the digital enhancement system 700 further includes a second data set 706 encoded in the three dimensional color space. The second data set 706 includes a data range corresponding to a second flesh tone range derived from measured flesh tones of subjects in a second ethnicity class that is unique from the first ethnicity class.

The system 700 further includes an input 708 that is operable to receive image data 710 including data corresponding to at least one human subject. The received image data 710 is preferably encoded in a multidimensional color space. In addition, the system 700 incorporates an isolator 712 that is configured to isolate at least one facial region in the received image data 710. The digital image enhancement system 700 further incorporates a comparator 714 that is operable to compare image data in the at least one facial region with the first data set 704 and the second data set 706. The system 700 also includes an image correction signal generator 718 configured to generate an image correction signal 718 representative of whether the facial region is aligned with the first data set 704 or the second data 706 set in accordance with an output of the comparator 714.

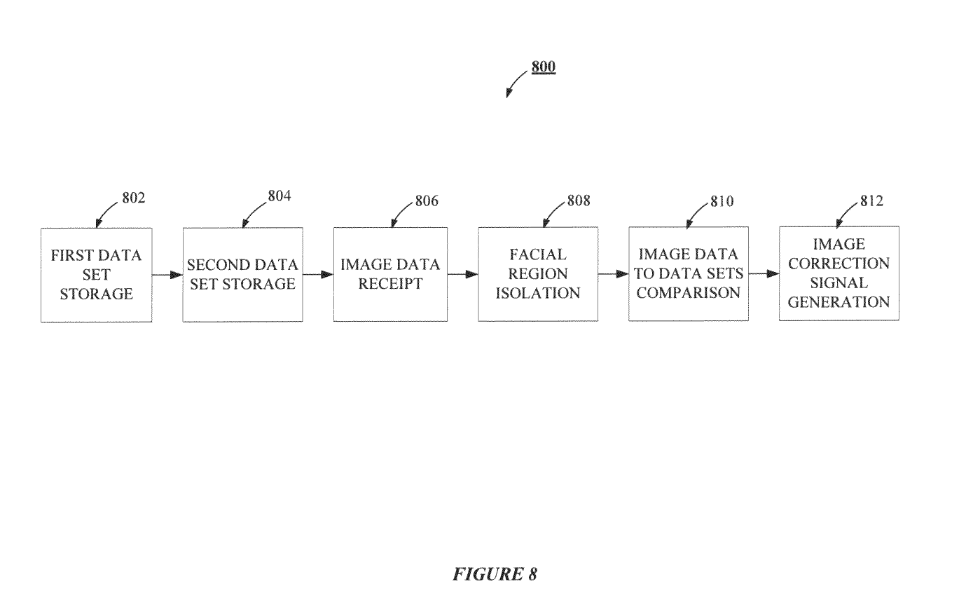

Referring now to FIG. 8, there is shown a functional diagram illustrating the system 800 for digital image classification in accordance with one embodiment of the subject application. As shown in FIG. 8, first data set storage 802 is performed of a data set encoded in a three dimensional color space in an associated memory, with the set including a data range that corresponds to a first flesh tone range derived from measured tones of subjects in a first ethnicity class. Next, second data set storage 804 is performed of a data set encoded in the three dimensional color space. The second data set includes a data range corresponding to a second flesh tone range derived from measured flesh tones of subjects in a second ethnicity class that is unique from the first ethnicity class.

Image data receipt 806 then occurs of image data encoded in a multidimensional color space that includes data corresponding to one or more human subjects. Facial region isolation 808 is then performed on the received image data. Image data to data sets comparison 810 is then performed of the image data to the first and second data sets via a processor operable in conjunction with the memory. Image correction signal generation 812 is then performed so as to generate a signal representing whether the facial region is aligned with the first data set or with the second data set based upon the results of the comparison 810.

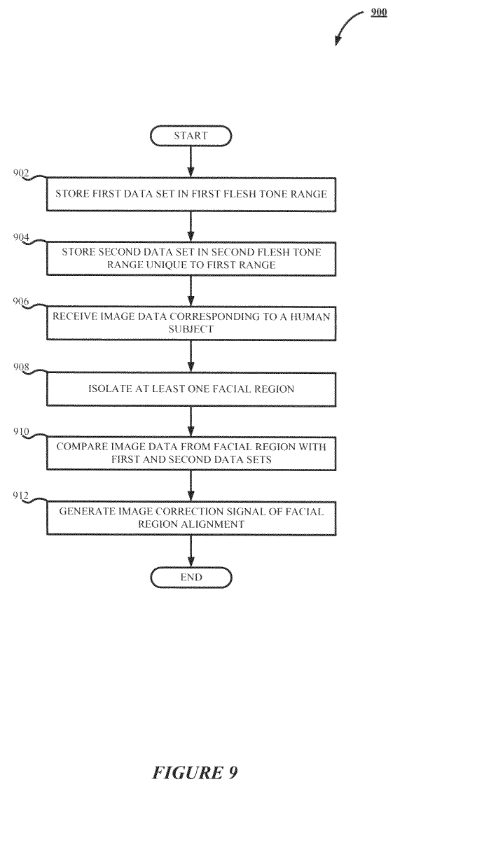

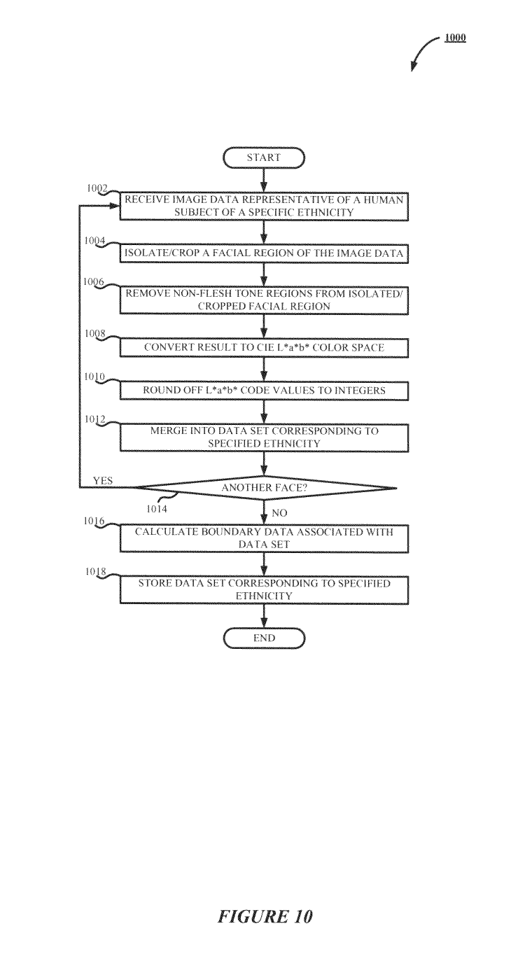

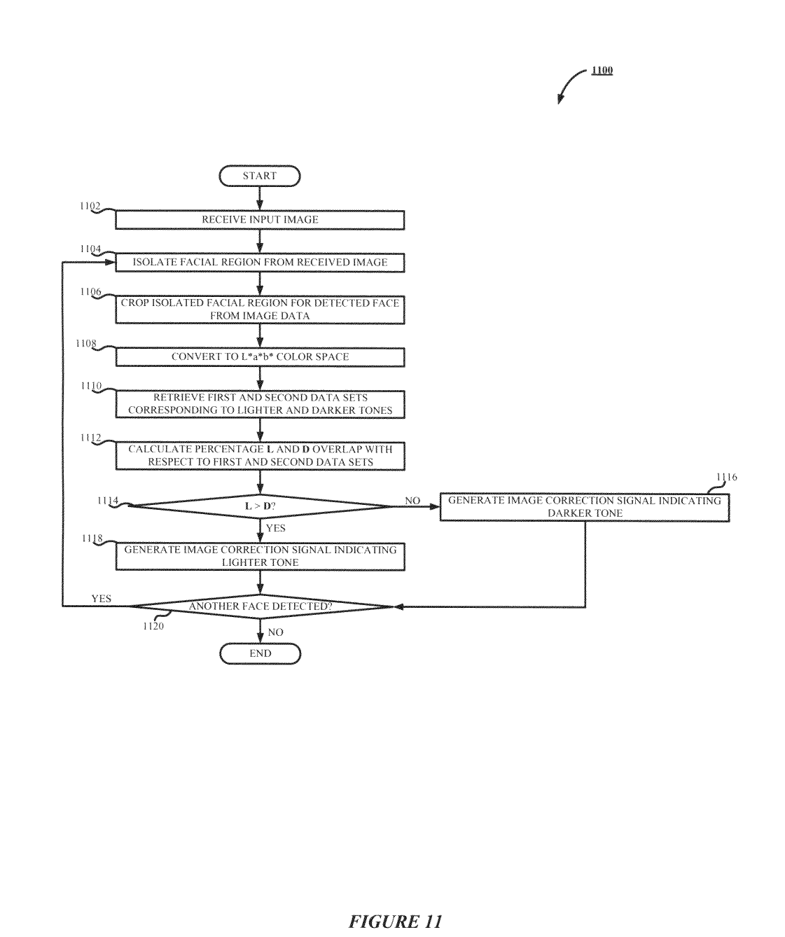

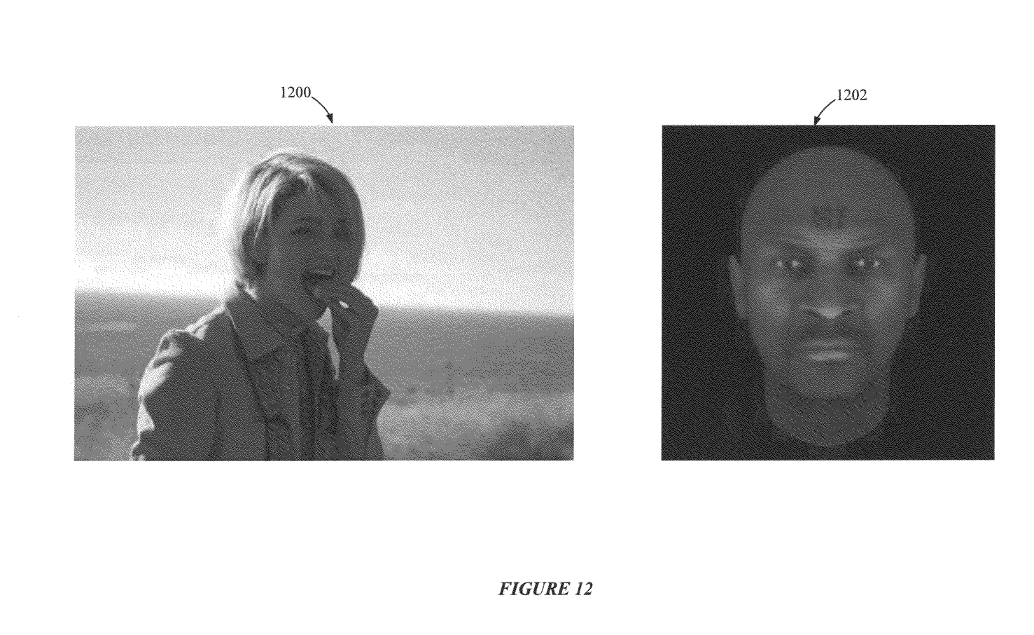

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9, FIG. 10, and FIG. 11, as well as the example implementations illustrated in FIGS. 12-35. Turning now to FIG. 9, there is shown a flowchart 900 illustrating a method for digital image classification in accordance with one embodiment of the subject application. Beginning at step 902, a first data set encoded in a three dimensional color space is stored in a memory. According to one embodiment of the subject application, the first data set includes a data range that corresponds to a first flesh tone range derived from the measured flesh tones of a plurality of subjects in a first ethnicity class.

At step 904, a second data set encoded in the three dimensional color space is stored in the memory. Preferably, the second data set includes a data range corresponding to a second flesh tone range derived from the measured flesh tones of a plurality of subjects in a second ethnicity class that is unique to the first ethnicity class. Image data is then received at step 906 corresponding to at least one human subject, with the image data being encoded in a multidimensional color space. At least one facial region in the received image data is then isolated at step 908. The image data in the at least one facial region is then compared at step 910 with the first data set and the second data set via a processor that operates in conjunction with the memory. An image correction signal is then generated at step 912 representing whether the at least one facial region is aligned with the first data set or the second data set in accordance with an output of the comparison performed at step 910.

Referring now to FIG. 10, there is shown a flowchart 1000 illustrating a method for digital image classification in accordance with one embodiment of the subject application. The methodology of FIG. 10 begins at step 1002, whereupon image data representative of a human subject of a specific ethnicity is received by the controller 108, the user device 116, or other suitable processing component associated with the digital image classification system 100 of the subject application. It will be appreciated by those skilled in the art that such image data is capable of being received via collection from a specified source, via generation of a synthesized subject from a desired ethnicity, or the like.

In accordance with one example embodiment of the subject application, the flesh tone colors around the face of a human subject form a three-dimensional cluster in a color space, e.g. RGB, YCbCr, CIE L*a*b*, or the like, referenced in this application as a facial tone cluster. According to a preferred embodiment of the subject application, two facial tone cluster models (also referenced herein as the first and second data sets), one for naturally darker facial tones, e.g. African ethnicity, some Indian ethnicities, and the like, and one for the rest, i.e. naturally lighter facial tones, e.g. European ethnicities, most Asian ethnicities, and the like. These facial tone cluster models, or data sets, are suitably developed via the collection of faces representing typical flesh tone colors of specific ethnic groups, cropping off non-flesh tone regions such as eyes, nose and lips, converting to L*a*b* color space, rounding off L*a*b* code values to integers, and merging them to form base models. According to one embodiment of the subject application, base facial tone cluster models, or data sets, are enhanced by adding faces under various lighting conditions and further enhanced by adding training samples that were misidentified to form the final data sets, i.e. the final facial tone cluster models. Preferably, the two facial tone cluster models are built beforehand and the respective model data are stored prior to determining the facial tone (lighter or darker) of an input image. When an input image is received, face detection is applied to locate a human face in the image, the facial region is then cropped off, the two sets of facial tone cluster model data are retrieved from storage and a comparison is made to determine if the cropped facial region overlaps more with the darker model (data set) or overlaps more with the lighter model (data set). This overlap facilitates in the determination of to which ethnic group the human face in the input image most likely belongs.

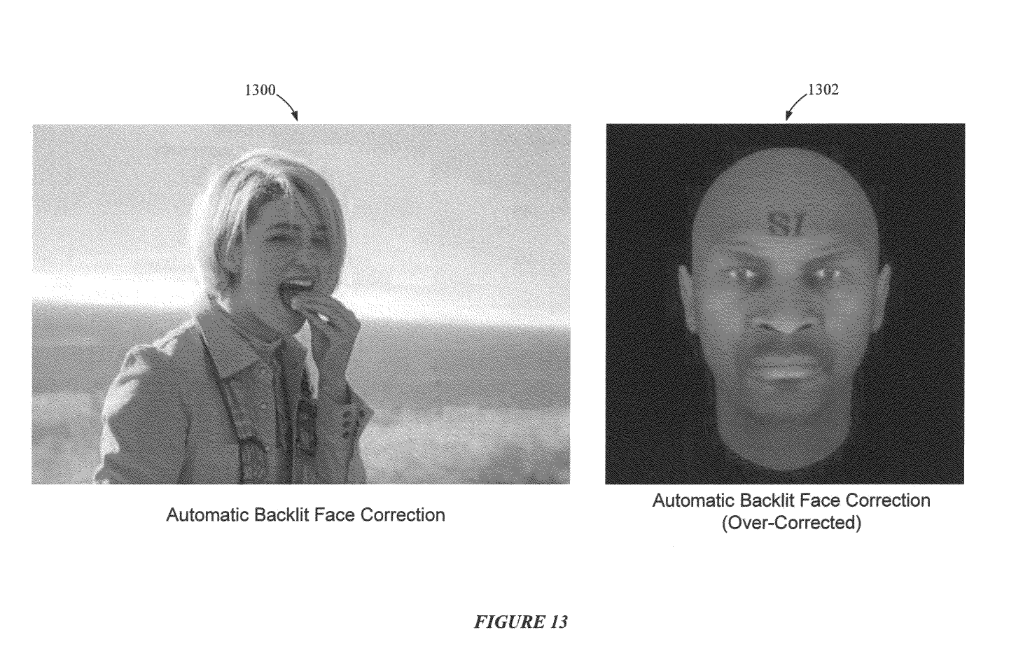

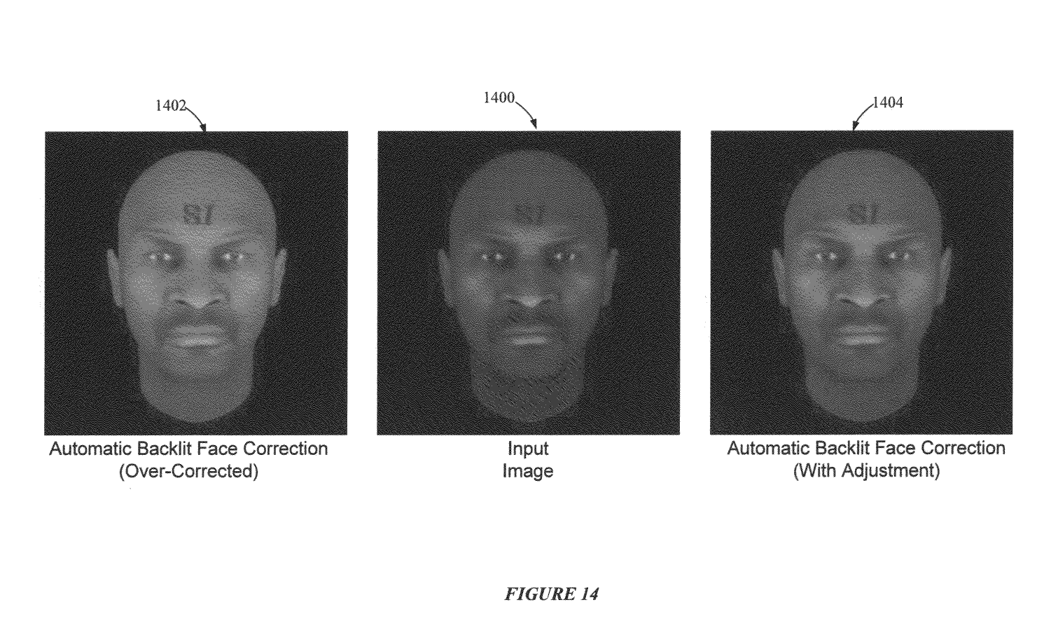

The skilled artisan will appreciate that backlit faces are capable of being detected and corrected automatically by cropping off the facial region of a human face in an image, examining the darkness and the size of the face to determine the severity of the situation, and applying proper amount of brightening according to the severity according to the methodology described herein. FIG. 12 shows two images 1200 and 1202 with similar severity. FIG. 13 illustrates the result of the correction with the same amount of brightening such that the first image 1300 appears correct, but the second image 1302 appears over-corrected. The skilled artisan will appreciate that this occurs because the darkness of the face in second image 1302 is partially contributed by the fact that the face is naturally (ethnically) darker. Accordingly, once an estimate is made as to the ethnicity of a naturally darker face (e.g., African) then the amount of correction can be adjusted accordingly. FIG. 14 depicts the input image 1400, the over-correction 1402, and the result of adjusted brightness correction 1404.

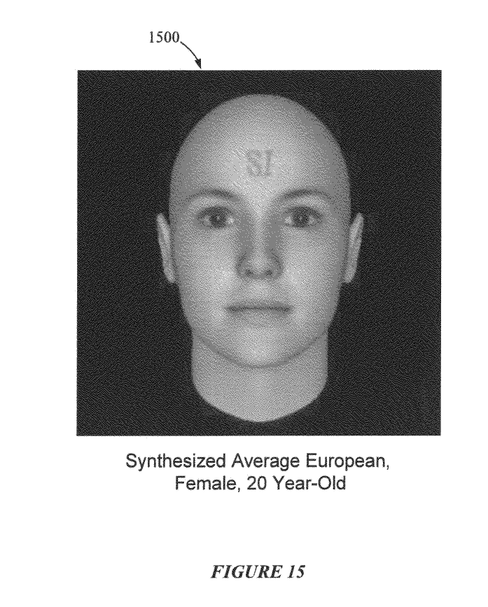

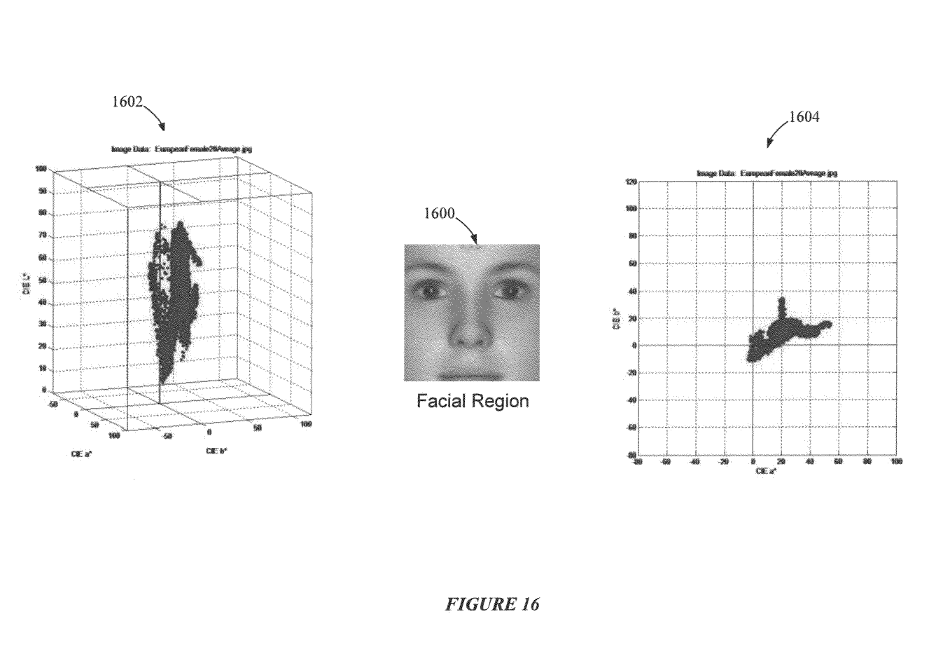

Returning to FIG. 10, after receipt of the image data at step 1002, flow progresses to step 1004, whereupon the facial region is isolated from the received image data. Preferably, the facial region of the human subject in the received image data is detected and cropped, as will be understood by those skilled in the art. FIG. 15 depicts an example input image 1500 corresponding to a synthesized average 20 year-old European female, i.e. a lighter skin tone, such as is received at step 1002. Step 1004 is suitably demonstrated in FIG. 16, which illustrates a cropped face 1600 from the input image 1500 and two views of the facial tone cluster 1602 and 1604, in L*a*b* color space.

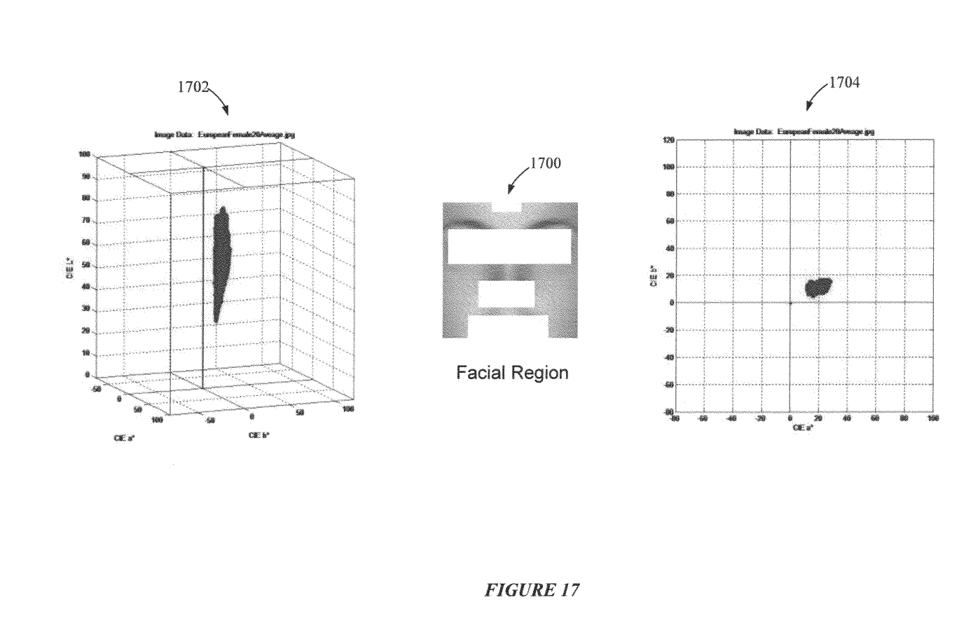

Any non-flesh tone portions of the isolated facial region are removed from the region at step 1006. As will be understood by those skilled in the art, the eyes, nose, lips, hair, and other components of the facial region having non-flesh tones are cropped out of the cropped facial region. Such a resulting image is shown in FIG. 17, which illustrates the cropped image 1700 with removed non-flesh tone portions, as well as two views of the facial tone cluster 1702 and 1704. At step 1008, the resulting facial region is then converted to CIE L*a*b* color space. The skilled artisan will appreciate that step 1008 may not be required if the received image data is already in CIE L*a*b* color space.

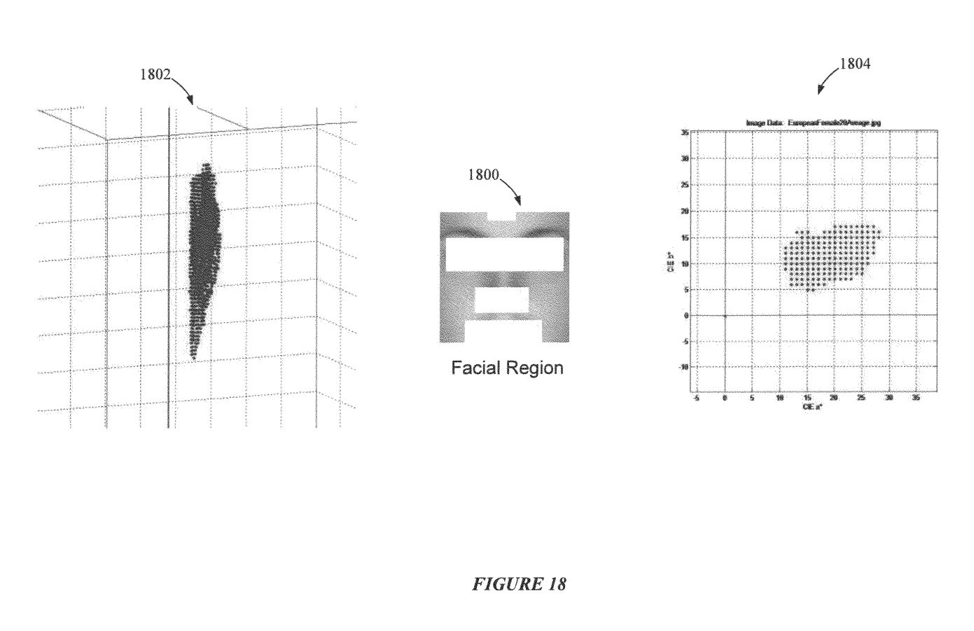

At step 1010, the L*a*b* code values are rounded off to integers. FIG. 18 illustrates the resulting code values after rounding off in the region 1800, and the resulting cluster views 1802 and 1804. At step 1012, the rounded off values are merged into the data set corresponding to the specified ethnicity. That is, the rounded off values are merged into a facial tone cluster model associated with the specific ethnicity of the human subject. A determination is then made at step 1014 whether another face is to be added to the data set. Upon a positive determination, flow returns to step 1002, whereupon image data representative of a human subject of a specified ethnicity is received.

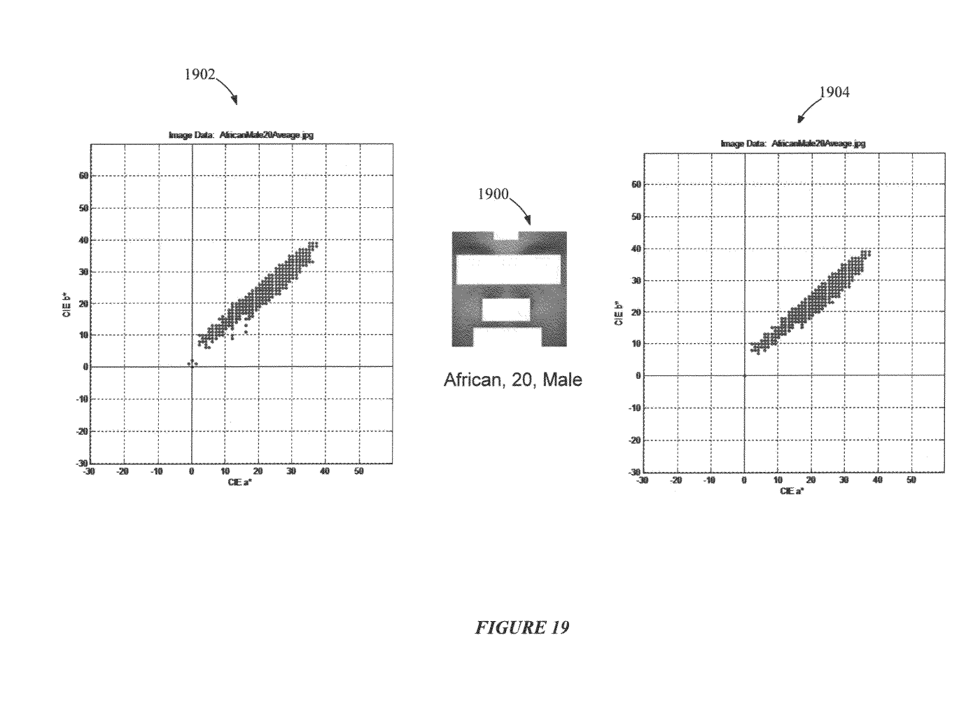

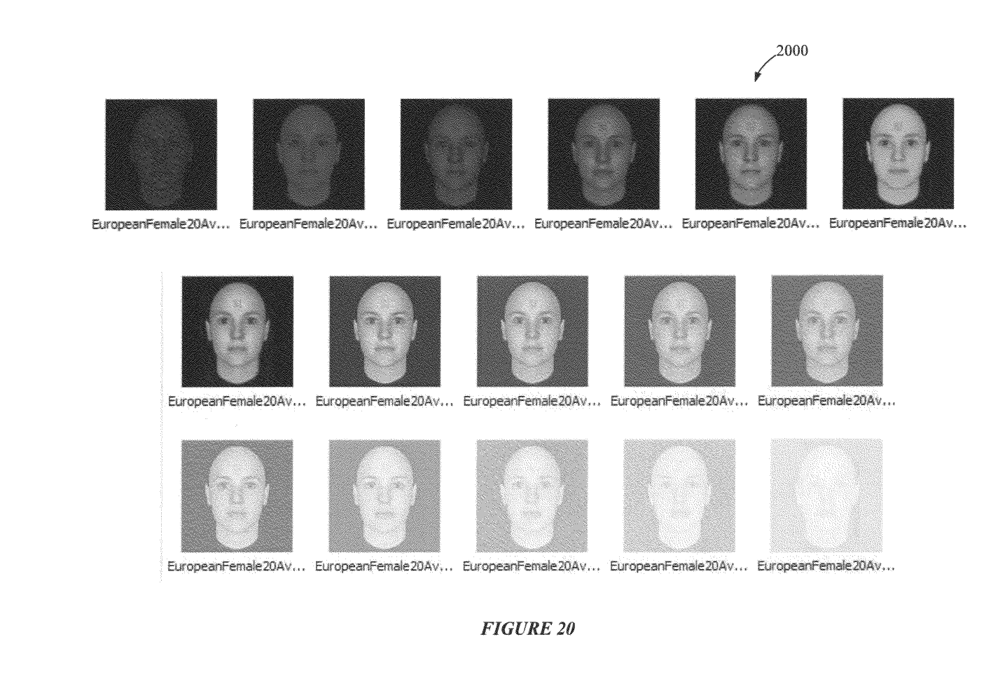

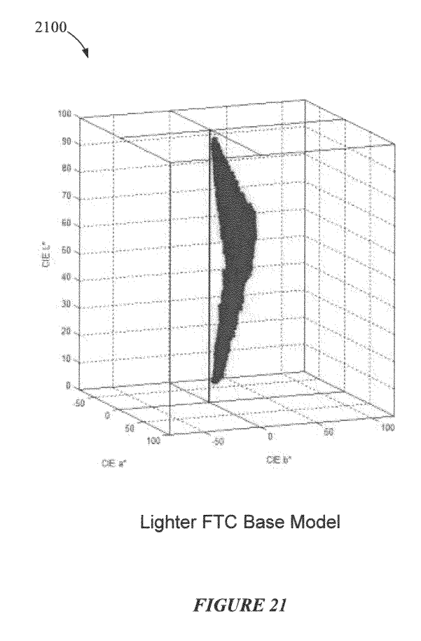

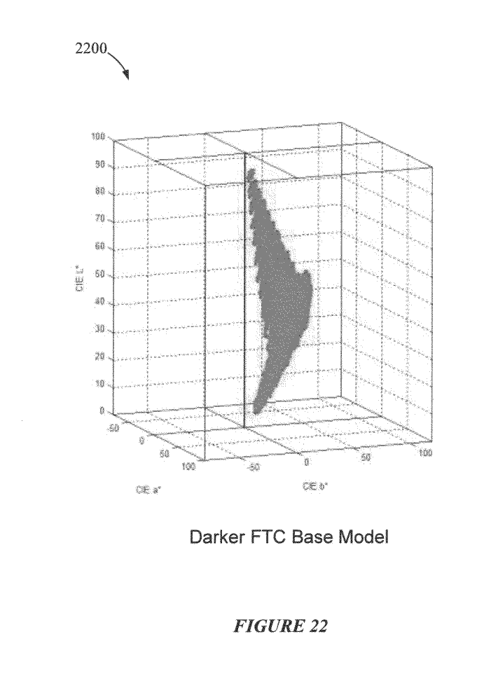

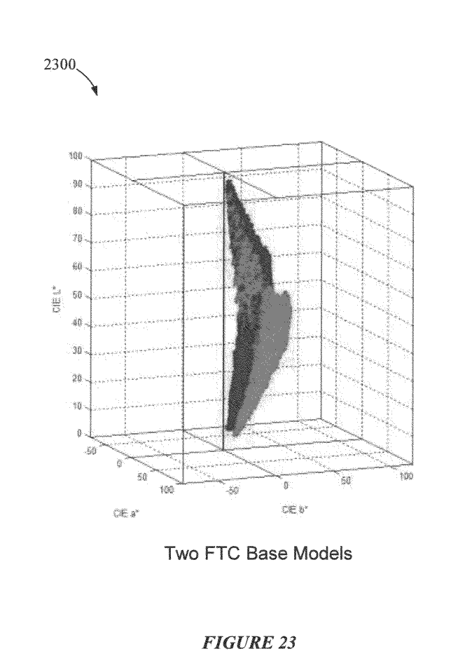

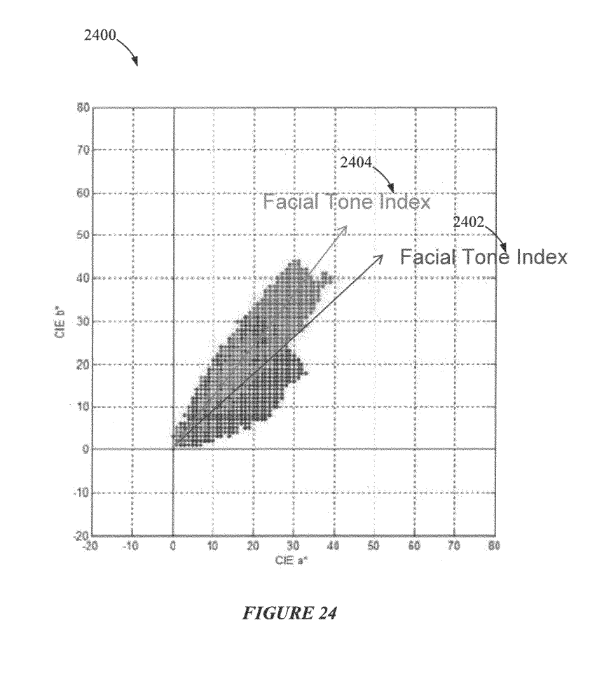

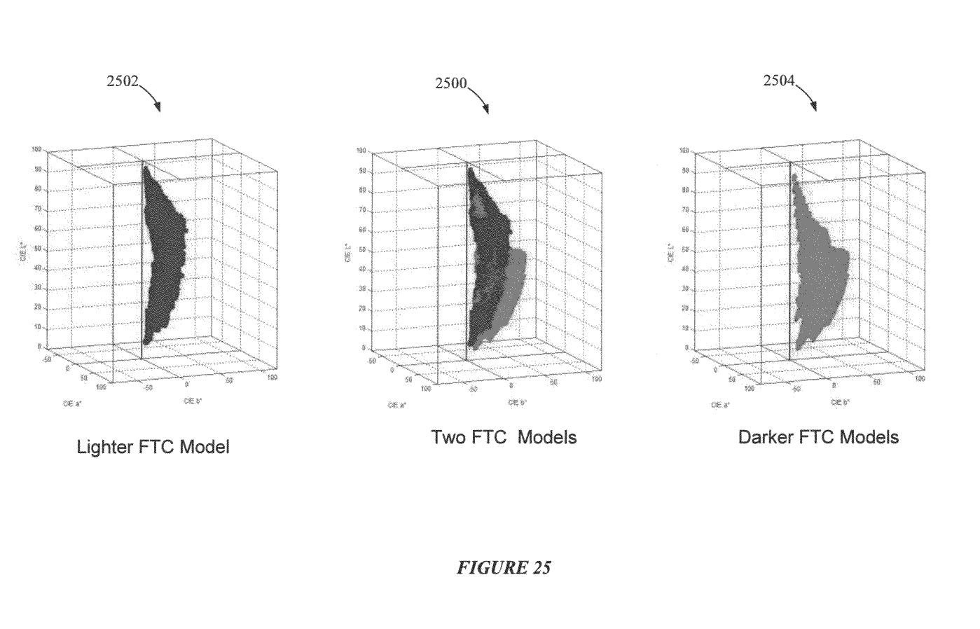

In accordance with one example embodiment of the subject application, additional images are received representative of the specific ethnicity, or flesh tone (darker or lighter). Accordingly, FIG. 19 illustrates a facial tone cluster of a typical 20-year-old average male African (input image 1900), the facial tone cluster 1902 before smoothing and the facial tone cluster 1904 after smoothing operators are applied to remove dangling or isolated points, as will be appreciated by those skilled in the art. FIG. 20 depicts sample faces 2000 that are systematically generated under various controlled lighting conditions. Such faces are generated for typical Europeans across different ages and genders, and the respective facial tone clusters are merged to form a base model for lighter facial tones, as illustrated by the base lighter facial tone cluster 2100 of FIG. 21. It will be understood by those skilled in the art that such a process is repeated so as to generate typical African faces across different ages and genders to form a base model for darker facial tones, i.e. the base darker facial tone cluster 2200 of FIG. 22. The skilled artisan will appreciate that the two data sets, i.e. the two facial tone cluster base models already show some separation between the two, as illustrated in the combined facial tone cluster 2300 of FIG. 23. FIG. 24 illustrates the two-dimensional projections 2400 onto the a*-b* plane and the fact that each facial tone index 2402 (lighter) and 2404 (darker) is merely a one-dimensional projection of the three-dimensional facial tone clusters. Preferably, the two data sets, or facial tone clusters, are enhanced by adding training samples that are typically misidentified by the facial tone cluster base models. FIG. 25 illustrates a final example of the two models 2500, the lighter facial tone colors model 2502, and the darker facial tone colors model 2504.

Returning to FIG. 10, operations continue as set forth above until a determination is made at step 1014 indicating that no additional faces are to be added to the data set. At step 1016, the boundary data associated with the facial tone cluster model is then calculated. According to one example embodiment of the subject application, the calculation of boundary data at step 1016 is accomplished via the generation of a three-dimensional binary matrix M having dimensions of 101, 121, and 121, which represents L* values from 0 to 100, a* values from −20 to 100, and b* values from −20 to 100, where:
M(I,J,K)=1, if there is a pixel P(i,j) in the facial tone cluster such that when its red, green, blue code values Rᵢⱼ, Gᵢⱼ, Bᵢⱼ, are translated into L*a*b* space as Lᵢⱼ, Aᵢⱼ, Bᵢⱼ, then I=Lᵢⱼ+1; J=Aᵢⱼ+21; K=Bᵢⱼ+21;
M(I,J,K)=0, otherwise.

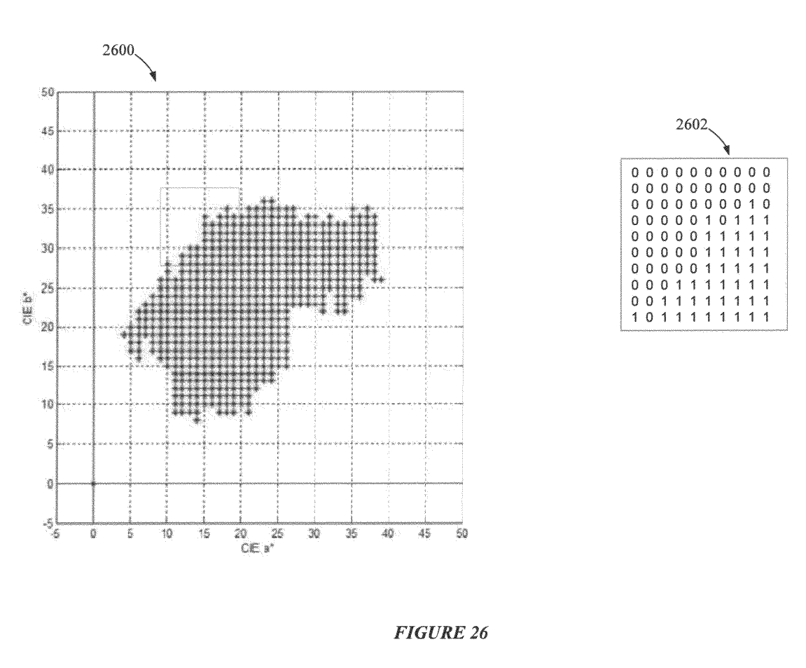

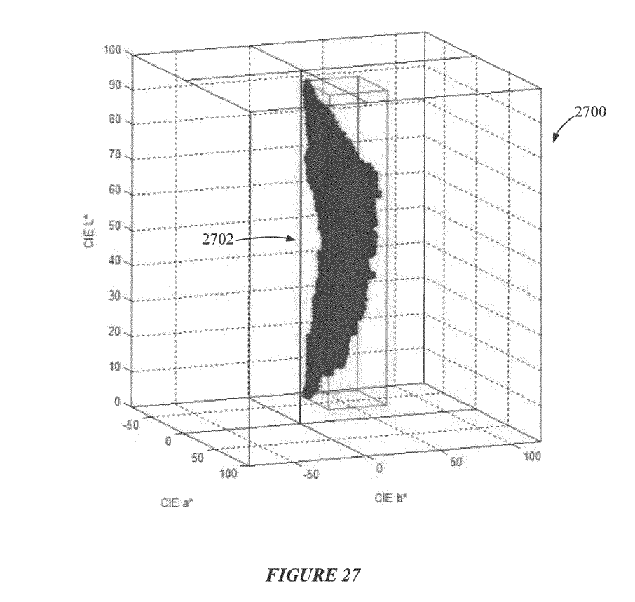

That is, the facial tone cluster (light or dark) is a set of discrete points in L*a*b* color space that corresponds to a three-dimensional binary matrix in which an entry is 1 if the color represented by the L*a*b* code values is a facial tone color, and the entry is 0 if the color represented by the L*a*b* code values is not a facial tone color. FIG. 26 illustrates a cross section 2600 at L*=55 of the facial tone cluster with a portion of the corresponding M matrix 2602. Following generation of the matrix M, a bounding box is developed for each facial tone cluster model, e.g. the lighter model and the darker model. FIG. 27 illustrates the bounding box 2702 of the lighter facial tone cluster 2700 in red. Thus, the minimum and maximum values for L*, a*, and b* are calculated, e.g. MinL, MaxL, MinA, MaxA, MinB and MaxB.

The calculation of the boundary data at step 1016 continues with the calculation of the facial tone cluster boundaries. Therefore, for each cross section of L* value, i, from MinL to MaxL, and for each a* value, j, from MinA to MaxA, the upper bound of b* values UpperB[i, j] and the lower bound of b* values LowerB[i, j] are calculated.

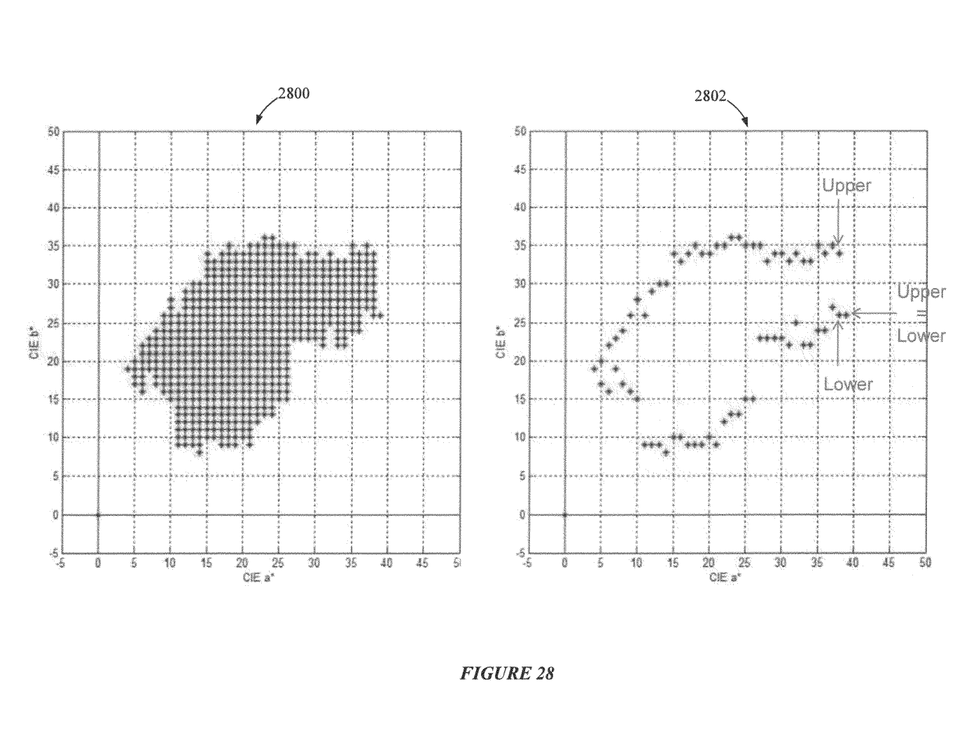

For example, FIG. 28 shows the lighter facial tone cluster model boundaries 2800 at cross section L*=55, and the lighter facial tone cluster model boundaries 2802 at cross section L*=55, at a*=38, the lower bound of b* values is 26 while the upper bound of b* values is 34, therefore, UpperB[55,38]=34 and LowerB[55,38]=26. In case lower bound equals upper bound, for example, at cross section L*=55 and at a*=39, then UpperB[55,39]=LowerB[55,39]=26. According to one example embodiment of the subject application, the upper bounds are initialized as a very small number, e.g., −500, while the lower bounds are initialized as a very large number, e.g., 500. The skilled artisan will appreciate that facial tone cluster model boundaries are calculated for both the lighter facial tone cluster model and the darker facial tone cluster model.

Following such a calculation at step 1016, flow proceeds to step 1018, whereupon the data set, or facial tone cluster and associated boundary data, corresponding to the specified ethnicity is stored in associated memory, e.g. the data storage device 110 associated with the document processing device 104, the data storage device associated with the user device 116, or the like. That is, a facial tone cluster model, i.e. the data set having a data corresponding to a flesh tone range in the specified ethnicity class is stored. For example, a first data set is stored when a lighter facial tone cluster model is being generated, the flesh tone range corresponds to lighter skin tones, whereas a second data set is stored when a darker facial tone cluster model is being generated, the flesh tone range corresponds to darker skin tones, or vice versa. Preferably, the stored boundary data includes the values MinL, MaxL, MinA, MaxA, MinB, MaxB, LowerB[i, j] and UpperB[i, j] of the lighter facial tone cluster model and the darker facial tone cluster model. Following storage of the data set, operations with respect to FIG. 10 terminate.

Turning now to FIG. 11, there is shown a flowchart illustrating the classification process according to one embodiment of the subject application. The method of FIG. 11 begins at step 1102, whereupon an input image is received for digital image classification in accordance with one embodiment of the subject application. It will be appreciated by those skilled in the art that such receipt is capable of occurring via operations of the document processing device 104, via operations of the digital camera 120, via communication via portable data storage, electronic mail transmission, or the like. For example purposes only, reference is made hereinafter to the user device 116 facilitating the processing of the methodology of FIG. 11.

After receipt of the image data at step 1102, operations progress to step 1104. In accordance with one embodiment of the subject application, such image data includes data corresponding to at least one human subject encoded in a multidimensional color space. At step 1104, a facial region is isolated from the received image data. It will be appreciated by those skilled in the art that such isolation is representative of the detection of a face of a human subject in the image data. The detection or isolation of the face in the image data is advantageously accomplished via any suitable means known in the art associated with such facial detection in electronic images. The facial region corresponding to the detected face is then cropped from the image data at step 1106.

Operations then proceed to step 1108, whereupon the user device 116 converts the cropped facial region to CIE L*a*b* color space. Any suitable techniques and methodologies known in the art for conversion of color data from one color space are capable of being used in accordance with the subject application. The skilled artisan will appreciate that step 1108 may not be necessary as the received image data is capable of being received in CIE L*a*b* color space.

The user device 116 then retrieves, from the associated memory 118, the first and second data sets corresponding to the lighter facial skin tone cluster and darker facial skin tone cluster at step 1110. According to one example embodiment of the subject application, boundary data for the lighter facial tone cluster model and boundary data for the darker facial tone cluster model are retrieved from memory 118.

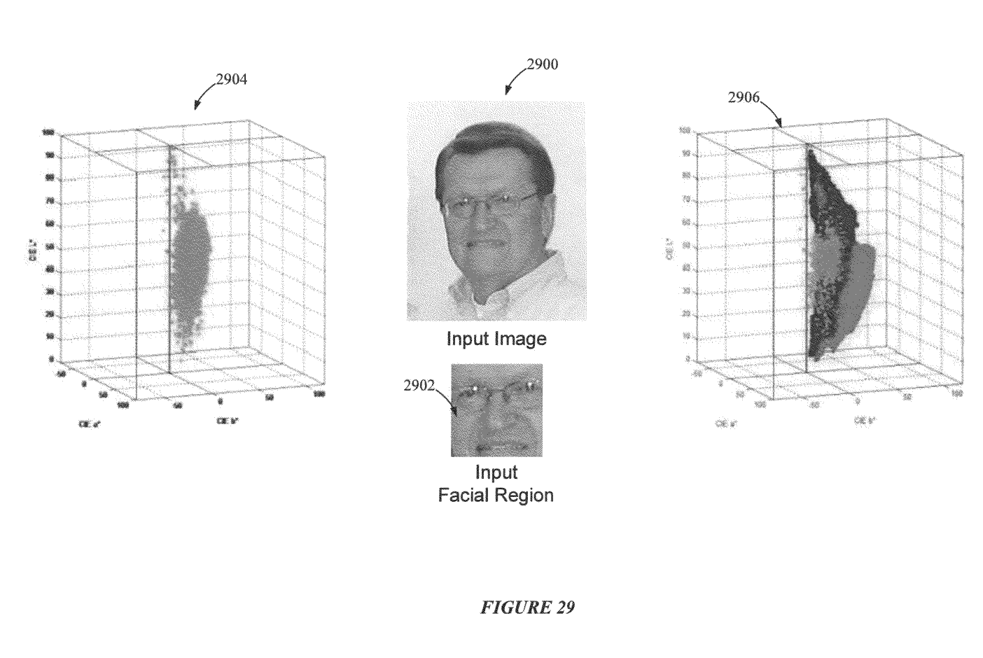

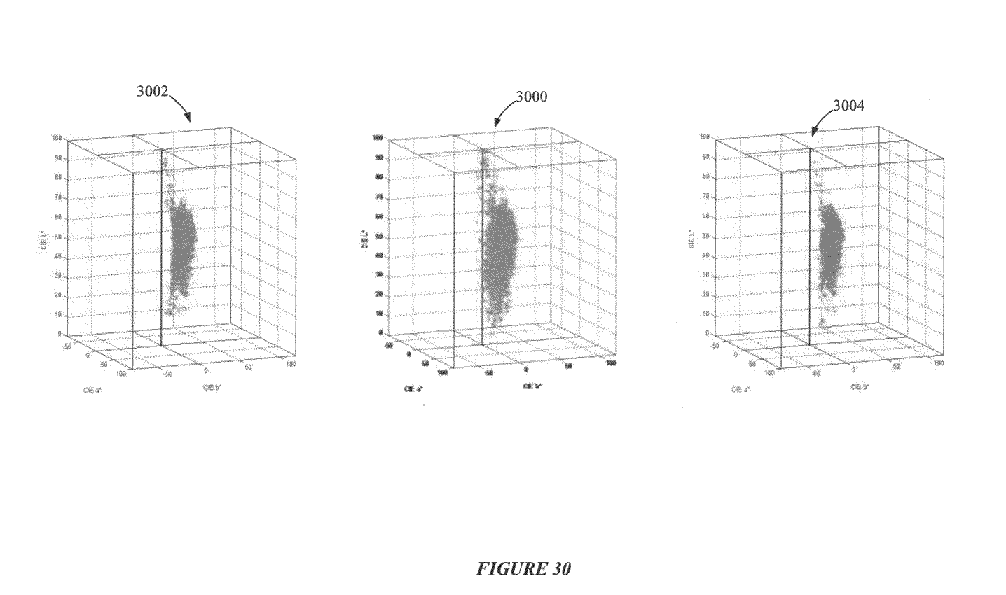

At step 1112, the user device 116 calculates the percentage overlap for lighter skin tones (L) and the percentage overlap for darker skin tones (D) with respect to the retrieved first and second data sets. FIG. 29 illustrates an example input image 2900, the cropped facial region 2902, the L*a*b* values of all the pixels in facial region colored in green in the graph 2904, with the cluster in blue for lighter facial tone and cluster in red for darker facial tone in the graph 2906. FIG. 30 shows the cluster of the input facial region 3000, and its overlapped portion with lighter facial tone cluster model 3002, and its overlapped portion with darker facial tone cluster model 3004. According to one embodiment of the subject application, by ranking the degree of overlap with lighter facial tone cluster model and darker facial tone cluster model, a determination is capable of being made as to whether the input facial region 3000 more likely belongs to lighter facial tone (European) 3002 or darker facial tone (African) 3004.

The calculation of the overlap is capable of being accomplished in accordance with the following example embodiment. The boundary data, i.e. the MinL, MaxL, MinA, MaxA, MinB, MaxB, LowerB[i, j] and UpperB[i, j] of the lighter facial tone cluster model (data set) and the darker facial tone cluster model (data set) is retrieved from the data storage device 118. For each pixel in the input facial region with L*a*b* code values L, A, B, respectively, a determination is made as to whether each value is within the bounding box of lighter facial tone cluster model, if not, then the pixel is not of the lighter facial tone. If not, a determination is made whether the b* value B is within the upper bound and lower bound of the lighter facial tone cluster model, i.e.,

LowerB[L,A]<=B<=UpperB[L,A].

If so, the pixel overlaps with the lighter facial tone cluster model and will be marked as in lighter facial tone. These steps are repeated for each pixel of the input facial region to determine if the pixel is to be marked as in darker facial tone.

The total number of pixels marked as in lighter facial tone is calculated and divided by the total number of pixels in the facial region, and with the resulting ratio recorded as the likelihood, i.e. percentage L, of this facial region as in lighter facial tone. The same calculations are performed to calculate the likelihood, i.e. percentage D, of this facial region as in darker facial tone.

A determination is then made at step 1114 whether L is greater than D. If L is not greater than D, flow proceeds to step 1116, whereupon an image correction signal is generated indicating the facial region corresponds to a darker tone. If L is greater than D, flow proceeds to step 1118, whereupon an image correction signal is generated indicating the facial region corresponds to a lighter tone. Thereafter, operations progress to step 1120, whereupon a determination is made whether another face has been detected in the received image data. Upon a positive determination at step 1120, flow returns to step 1104 for isolation from the image data. In the event that no additional faces are detected in the received image data, operations with respect to FIG. 11 terminate.

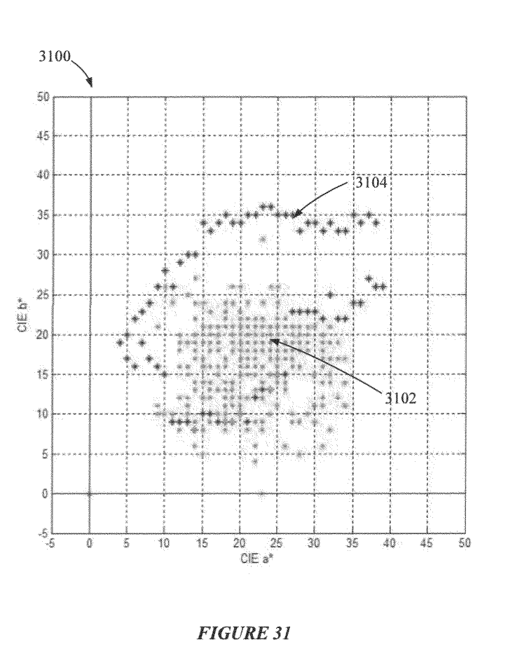

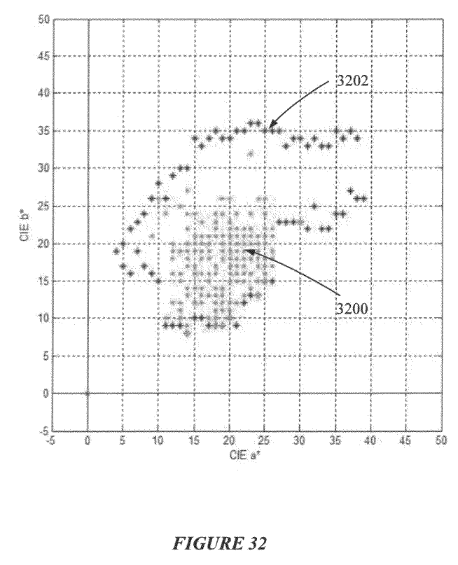

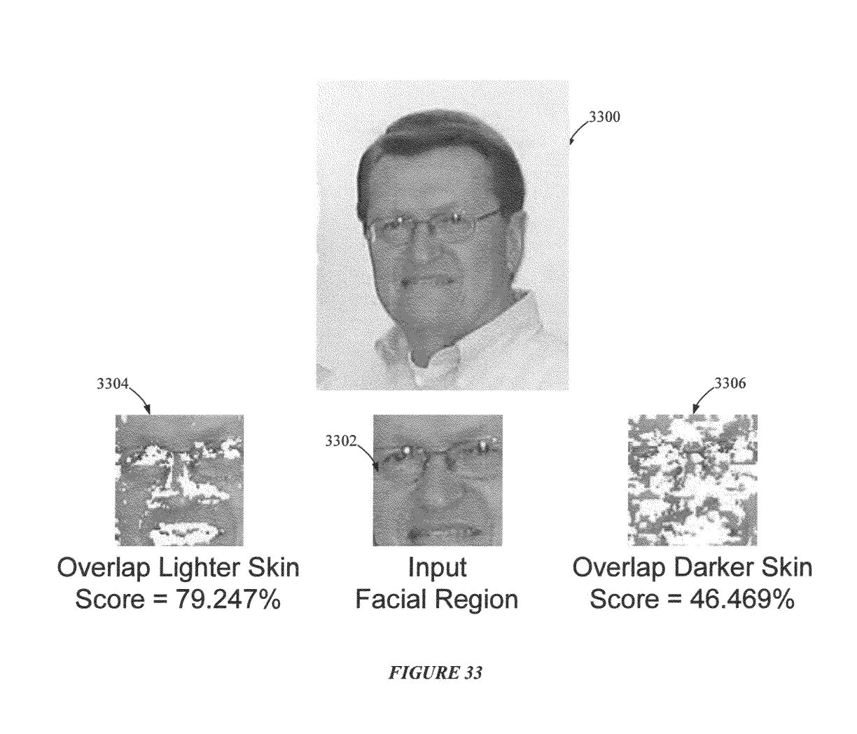

FIG. 31 illustrates the lighter facial tone cluster model boundaries 3100 (in blue) at L*=55 and the cross section of the facial tone cluster 3102 (in green) of the input facial region 2902 of the example in FIG. 29. FIG. 32 depicts only those pixels 3200 that fall within the lighter facial tone cluster model boundaries 3202, enabling the calculation of the number of pixels within the lighter boundaries 3202. FIG. 33 illustrates the example input image 3300, the cropped facial region 3302, and the pixels in the input facial region 3302 that are in the lighter facial tone class 3304 and in the darker facial tone class 3306. Thus, a comparison of the percentages L and D indicates that the input facial region 3302 is most likely not in darker facial tone class, i.e. L is greater than D.

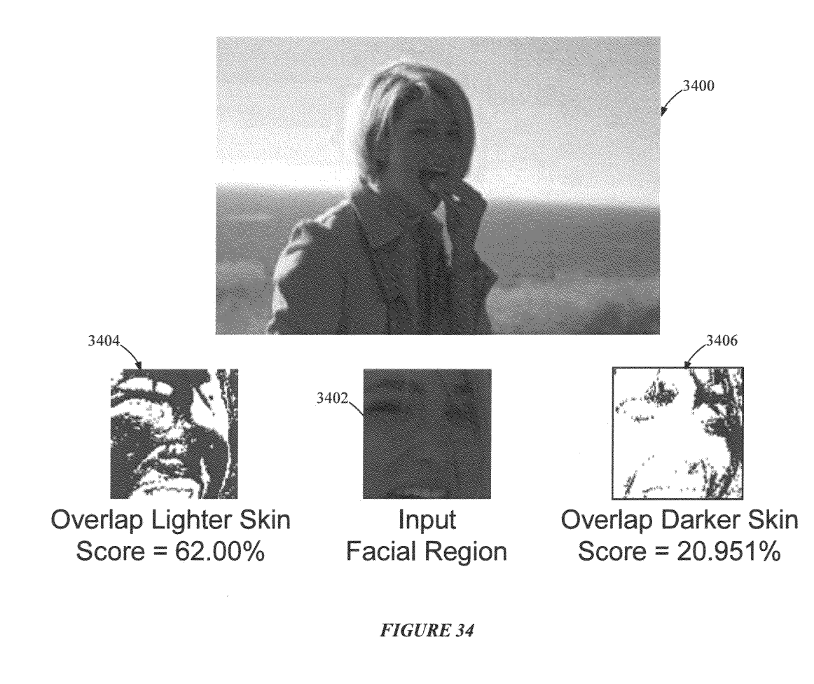

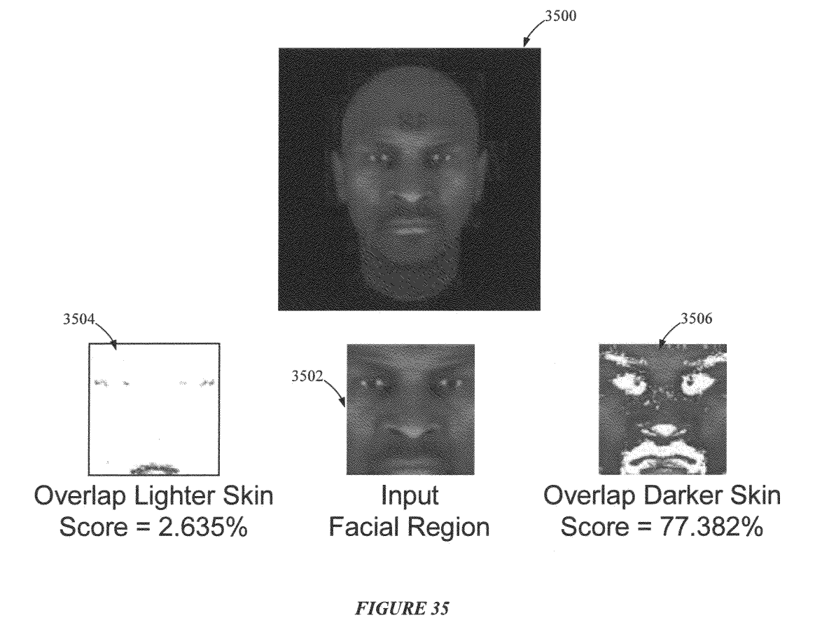

Further examples are illustrated in FIGS. 34 and 35, corresponding to the input images 1200 and 1202 of FIG. 12. As shown in FIG. 34, the input image 3400 is cropped to isolate the input facial region 3402. The various methodologies above are performed on the region 3402 to determine the overlap. The lighter facial tone model overlap 3404 is illustrated as L=62.00% while the darker facial tone model overlap 3406 indicates D=20.951%, where L>D, indicative of a classification as most likely lighter in facial tone. In contrast, the input image 3500 of FIG. 35 is indicative of a darker skin tone classification. Thus, the input image 3500 is cropped to isolate the input facial region 3502, and the percentage overlap is calculated as set forth above. The lighter facial tone model overlap 3504 is illustrated as L=2.635% while the darker facial tone model overlap 3506 indicates D=77.382%, where L<D, indicative of a classification as most likely darker in facial tone. Thus, the backlit (dark) face correction for faces in the naturally darker facial tone class should be adjusted as illustrated in FIG. 14.

The skilled artisan will appreciate that the facial tone clusters mentioned above are also capable of being constructed in other color spaces, e.g. YCbCr. However, CIE L*a*b* color space is a device-independent color space unlike RGB or YCbCr which are device-dependent. The conversion to L*a*b* may be more costly than the conversion to YCbCr, nevertheless, the cropped facial region is typical small after the input image is usually scaled down to less than or equal to VGA resolution (640 by 480) for face detection, therefore, the difference in conversion cost is insignificant.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A digital image classification system comprising:
a memory, the memory storing a first data set encoded in a three dimensional color space, the first data set including a data range corresponding to a first flesh tone range derived from measured flesh tones of a plurality of subjects in a first ethnicity class;
the memory further storing a second data set encoded in the three dimensional color space, the second data set including a data range corresponding to a second flesh tone range derived from measured flesh tones of a plurality of subjects in a second ethnicity class unique to the first ethnicity class;
an input operable to receive image data including data corresponding to at least one human subject, which image data is encoded in a multidimensional color space;
an isolator operable to isolate at least one facial region in the received image data;
a comparator operable to compare image data in the at least one facial region with the first data set and the second data set; and
an image correction signal generator operable to generate an image correction signal representative of whether the at least one facial region is aligned with the first data set or the second data set in accordance with an output of the comparator.

2. The system of claim 1 further comprising an image data adjuster operable to adjust encoding of image data in the at least one facial region relative to an area outside thereof in accordance with the image correction signal.

3. The system of claim 2 wherein the comparator is operable as a function of a relative overlap of the first data set and the second data set to the at least one facial region.

4. The system of claim 3 wherein the first data set, the second data set and the at least one facial region are encoded in L*a*b* color space.

5. The system of claim 1 further comprising a data set generator operable to generate each data set in accordance with a corresponding measured plurality of subjects in the first ethnicity class and the second ethnicity class, which measurements exclude non-flesh tone regions of the subjects.

6. The system of claim 5 wherein the non-flesh tone regions include eye regions and hair regions of the plurality of subjects.

7. A method of digital image classification comprising:
storing a first data set encoded in a three dimensional color space in a memory, the first data set including a data range corresponding to a first flesh tone range derived from measured flesh tones of a plurality of subjects in a first ethnicity class;
storing a second data set encoded in the three dimensional color space in the memory, the second data set including a data range corresponding to a second flesh tone range derived from measured flesh tones of a plurality of subjects in a second ethnicity class unique to the first ethnicity class;
receiving image data including data corresponding to at least one human subject, which image data is encoded in a multidimensional color space;
isolating at least one facial region in the received image data;
comparing image data in the at least one facial region with the first data set and the second data set via a processor operating in conjunction with the memory; and
generating an image correction signal representative of whether the at least one facial region is aligned with the first data set or the second data set in accordance with an output of the comparing step.

8. The method of claim 7 further comprising adjusting an encoding of image data in the at least one facial region relative to an area outside thereof in accordance with the image correction signal.

9. The method of claim 8 wherein the comparing is completed as a function of a relative overlap of the first data set and the second data set to the at least one facial region.

10. The method of claim 9 wherein the first data set, the second data set and the at least one facial region are encoded in L*a*b* color space.

11. The method of claim 7 wherein the generating includes generating each data set in accordance with a corresponding measured plurality of subjects in the first ethnicity class and the second ethnicity class, which measurements exclude non-flesh tone regions of the subjects.

12. The method of claim 11 wherein the non-flesh tone regions include eye regions and hair regions of the plurality of subjects.

13. A system of digital image classification comprising:
means adapted for storing a first data set encoded in a three dimensional color space in a memory, the first data set including a data range corresponding to a first flesh tone range derived from measured flesh tones of a plurality of subjects in a first ethnicity class;
means adapted for storing a second data set encoded in the three dimensional color space in the memory, the second data set including a data range corresponding to a second flesh tone range derived from measured flesh tones of a plurality of subjects in a second ethnicity class unique to the first ethnicity class;
means adapted for receiving image data including data corresponding to at least one human subject, which image data is encoded in a multidimensional color space;
means adapted for isolating at least one facial region in the received image data;
means adapted for comparing image data in the at least one facial region with the first data set and the second data set via a processor operating in conjunction with the memory; and
means adapted for generating an image correction signal representative of whether the at least one facial region is aligned with the first data set or the second data set in accordance with an output of the means adapted for comparing.

14. The system of claim 13 further comprising means adapted for adjusting an encoding of image data in the at least one facial region relative to an area outside thereof in accordance with the image correction signal.

15. The system of claim 14 wherein the means adapted for comparing image data is completed as a function of a relative overlap of the first data set and the second data set to the at least one facial region.

16. The system of claim 15 wherein the first data set, the second data set and the at least one facial region are encoded in L*a*b* color space.

17. The system of claim 13 wherein the means adapted for generating includes means adapted for generating each data set in accordance with a corresponding measured plurality of subjects in the first ethnicity class and the second ethnicity class, which measurements exclude non-flesh tone regions of the subjects.

18. The system of claim 17 wherein the non-flesh tone regions include eye regions and hair regions of the plurality of subjects.
